(19) United States
(12) Patent Application Publication
(10) Pub. No.: US 2008/0100562 A1
(43) Pub. Date: May 1, 2008

(54) COLOR LIQUID CRYSTAL DISPLAY AND DRIVING METHOD THEREOF

(75) Inventors: Jih-Fon Huang, Hsinchu County (TW); Chao-Hsu Tsai, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/624,696

(22) Filed: Jan. 19, 2007

(30) Foreign Application Priority Data
Oct. 27, 2006 (TW) 95139745

(51) Int. Cl. G09G 3/36

(52) U.S. Cl. 345/102

(57) ABSTRACT

A color liquid crystal display including a back light module and a liquid crystal display (LCD) panel disposed thereon is provided. The back light module has a plurality of light sources emitting different kinds of color lights. The LCD panel includes an active device array substrate, an opposition substrate, and a liquid crystal layer. The opposition substrate is disposed above the active device array substrate, and the liquid crystal layer is disposed between the opposition substrate and the active device array substrate. Both the active device array substrate and the opposition substrate do not have a color filter layer. Therefore, the LCD has better light utility.

### CROSS-REFERENCE TO RELATED APPLICATION

This application claims the priority benefit of Taiwan application serial no. 95139745, filed on Oct. 27, 2006. All disclosure of the Taiwan application is incorporated herein by reference.

### BACKGROUND OF THE INVENTION

1. Field of the Invention

The present invention relates to a display, and more particularly to a color liquid crystal display.

2. Description of Related Art

Due to the increasing demand for display products around the world, considerable efforts are now invested on their development and production. In the past, cathode ray tubes have dominated the market of displays because of its excellent display quality and technological maturity. However, with our increasing awareness of the need to protect the environment in recent years, the larger consumption of power and the production of hazardous radiation by the CRT are no longer acceptable. Therefore, thin film transistor liquid crystal display (TFT-LCD), with its high display quality, smaller volume, lower power consumption, radiation-free, has gradually become the mainstream display products in the market.

The thin film transistor liquid crystal display comprises a liquid crystal display (LCD) panel and a back light module. The LCD panel comprises a thin film transistor array substrate, a color filter substrate and a liquid crystal layer disposed between the two substrates. In addition, the back light module is used for providing the LCD panel with the required plane light source so that the thin film transistor liquid crystal display is capable of displaying image.

FIG. 1 is a schematic diagram showing a conventional liquid crystal display. In a conventional liquid crystal display as shown in FIG. 1, when the intensity of a light beam emitted from the light source 1110 inside the back light module 1100 is 100%, the intensity of the light beam is reduced to 60% after passing through the diffuser 1120. Then, after the light beam from the light source 1110 has passed through the bottom polarizer 1210 of the LCD panel 120, the intensity of the light beam is further reduced to 24%. When the light beam from the light source 1110 passes through the liquid crystal layer 1220, the intensity of the light beam is further reduced to 23%. Thereafter, when the light beam emitted from the light source 1110 passes through the color filter layer 1230, only 6% of the original light intensity remains.

After the light beam from the light source 1110 has passed through the top polarizer 1240, the intensity of the light beam is reduced to 5%. Finally, after the light beam from the light source 1110 has passed through the uppermost optical film 1250, the intensity of the light beam is reduced to 4%. In other words, the conventional liquid crystal display 1200 can provide a luminance only about 5% of the luminance of the light source 1110.

### SUMMARY OF THE INVENTION

Accordingly, the present invention is directed to provide a color liquid crystal display for increasing light utility.

Additionally, the present invention is directed to provide a driving method for simplifying the driving of a color liquid crystal display.

As embodied and broadly described herein, the invention provides a color liquid crystal display including a back light module and a liquid crystal display (LCD) panel disposed thereon. The back light module has a plurality of light sources emitting different kinds of color lights. The LCD panel includes an active device array substrate, an opposition substrate, and a liquid crystal layer. The opposition substrate is disposed above the active device array substrate, and both the active device array substrate and the opposition substrate do not have a color filter layer. The liquid crystal layer is disposed between the opposition substrate and the active device array substrate.

As embodied and broadly described herein, the present invention also provides a driving method for driving a liquid crystal display (LCD) panel. The LCD panel comprises a plurality of scan lines, a plurality of data lines and a plurality of pixel units. The two neighboring pixel units electrically connected to the same scan line are located on two sides of the scan line respectively. Furthermore, the scan lines are sequentially divided into a plurality of groups. The driving method includes the following steps. First, the odd-numbered groups of scan lines are sequentially turned on and a signal with first polarity is input to the pixel units controlled by the odd-numbered groups of scan lines through the data lines. Thereafter, the even-numbered groups of scan lines are sequentially turned on and a signal with second polarity is input to the pixel units controlled by the even-numbered groups of scan lines through the data lines. Furthermore, the signal with first polarity and the signal with second polarity have opposite polarities.

As embodied and broadly described herein, the present invention also provides another driving method for driving a liquid crystal display (LCD) panel. The LCD panel has a plurality of scan lines, a plurality of data lines and a plurality of pixel units. The two neighboring pixel units connected to the same scan line are located on two sides of the scan line respectively. Furthermore, the scan lines are sequentially divided into groups and each group of scan lines includes two scan lines. The driving method includes the following steps. First, the odd-numbered groups of scan lines are sequentially turned on, and a signal with first polarity is sequentially input to the pixel units controlled by the odd-numbered groups of scan lines through odd-numbered data lines and a signal with second polarity and the signal with first polarity are sequentially input to the pixel units controlled by the odd-numbered groups of scan lines through the even-numbered data lines. Thereafter, the even-numbered groups of scan lines are sequentially turned on, and the signal with second polarity is sequentially input to the pixel units controlled by the even-numbered groups of scan lines through odd-numbered data lines and the signal with first polarity and the signal with second polarity are sequentially input to the pixel units controlled by the even-numbered groups of scan lines through the even-numbered data lines.

As embodied and broadly described herein, the present invention also provides yet another driving method for driving a liquid crystal display (LCD) panel. The LCD panel has a plurality of scan lines, a plurality of data lines and a plurality of pixel units. The two neighboring pixel units connected to the same scan line are located on two sides of the scan line respectively. Furthermore, the scan lines are sequentially divided into groups and each group of scan lines includes two scan lines. The driving method includes the following steps. First, the odd-numbered groups of scan lines are sequentially turned on, and a signal with second polarity and a signal with first polarity are sequentially input to the pixel units controlled by the odd-numbered groups of scan lines through odd-numbered data lines and the signal with first polarity is sequentially input to the pixel units controlled by the odd-numbered groups of scan lines through the even-numbered data lines. Thereafter, the even-numbered groups of scan lines are sequentially turned on, and the first polarity and the signal with second polarity are sequentially input to the pixel units controlled by the even-numbered groups of scan lines through odd-numbered data lines and the signal with second polarity is sequentially input to the pixel units controlled by the even-numbered groups of scan lines through the even-numbered data lines.

Accordingly, since the present invention deploys light sources capable of emitting different color lights instead of using color filter layers, the fabrication of the opposition substrate may be simplified. In addition, the pixel units in the present invention are arranged alternately and are driven by a frame inversion driving method so as to achieve the dot inversion effect. Hence, the driving method is able to save power.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing the utility of light in a conventional liquid crystal display.

FIG. 2 is a schematic cross-sectional view of a color liquid crystal display according to a first embodiment of the present invention.

FIG. 3 is a schematic cross-sectional view of a color liquid crystal display according to a second embodiment of the present invention.

FIG. 4 is a schematic cross-sectional view of a color liquid crystal display according to a third embodiment of the present invention.

FIG. 5 is a schematic diagram showing the color liquid crystal display according to the third embodiment of the present invention.

FIG. 6 is a diagram showing a first driving method according to the present invention.

FIG. 7 is a diagram showing a second driving method according to the present invention.

FIGS. 8A and 8B are diagrams showing a third driving method according to the present invention.

FIGS. 9A and 9B are diagrams showing a fourth driving method according to the present invention.

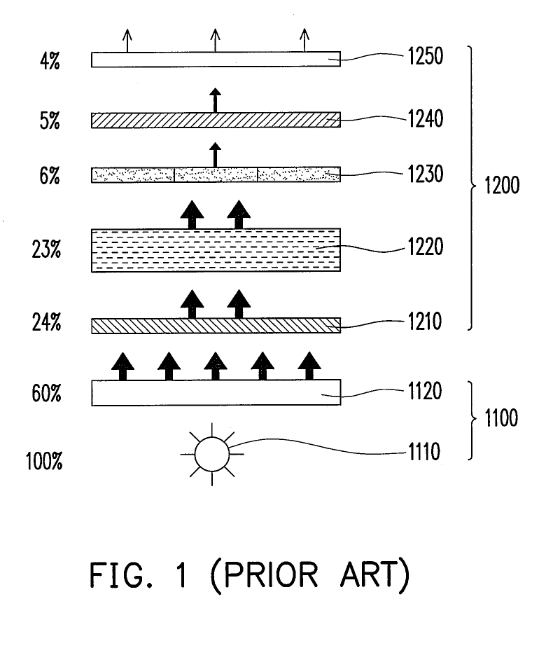

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

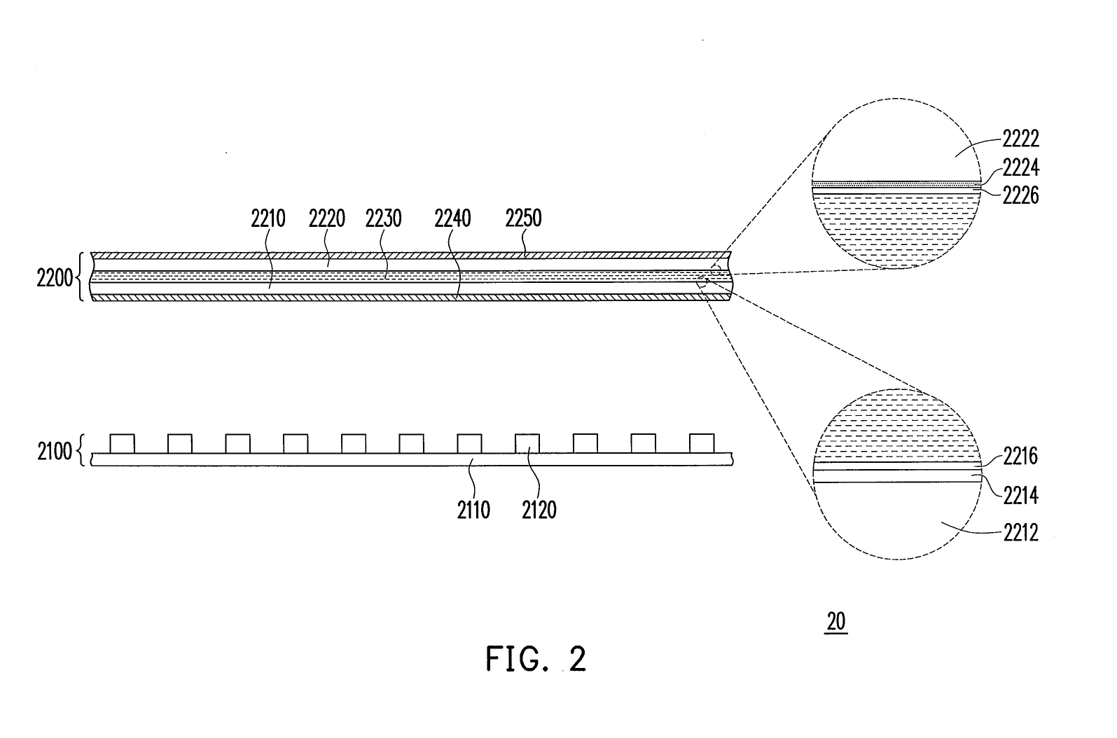

FIG. 2 is a schematic cross-sectional view of a color liquid crystal display according to a first embodiment of the present invention. As shown in FIG. 2, the color liquid crystal display 20 in the present embodiment includes a back light module 2100 and a liquid crystal display panel 2200. The liquid crystal display panel 2200 is disposed over the back light module 2100. More specifically, the back light module 2100 includes a back panel 2110 and a plurality of light sources 2120 disposed on the back panel 2110 for providing different color lights. Furthermore, the foregoing light sources 2120 include red dot light sources, blue dot light sources and green dot light sources, for example. In addition, the light sources 2120 are light-emitting diodes (LED), organic light-emitting diodes (OLED) or other types of dot light sources, for example. In the present embodiment, the back light module 2100 is a direct-type back light module and the light sources 2120 are dot light sources. However, in other embodiments, the light sources 2120 may be linear light sources or plane light sources, and the back light module 2100 may be edge-type back light module.

The LCD panel 2200 includes an active device array substrate 2210, an opposition substrate 2220 and a liquid crystal layer 2230. The opposition substrate 2220 is disposed above the active device array substrate 2210, and the liquid crystal layer 2230 is disposed between the active device array substrate 2210 and the opposition substrate 2220. It should be noted that both the active device array substrate 2210 and the opposition substrate 2200 do not have a color filter layer. Therefore, the color LCD 20 in the present embodiment is able to display color through the light sources 2120 that emit different color lights.

In detail, the active device array substrate 2210 includes a first transparent substrate 2212, an active device layer 2214 and a first alignment film 2216. The active device layer 2214 is disposed on the first transparent substrate 2212 and the first alignment film 2216 is disposed on the active device layer 2214. In addition, the active device layer 2214 includes a plurality of scan lines, a plurality of data lines, a plurality of active devices and a plurality of pixel electrodes, and the scan lines and the data lines may serve as light-shielding layers. The opposition substrate 2220 includes a second transparent substrate 2222, a transparent conductive layer 2224 and a second alignment film 2226. The transparent conductive layer 2224 is disposed between the second transparent substrate 2222 and the second alignment film 2226. Furthermore, the first transparent substrate 2212 and the second transparent substrate 2222 may be flexible substrates or rigid substrate. The material of the flexible substrate includes, for example, polyethylene terephthalate (PET), polyimide (PI), polyethersulfone (PES), polycarbonate (PC) or other transparent and flexible material.

In the present embodiment, the opposition substrate 2220 has a transparent conductive layer 2224. However, when the color LCD 20 is applied to an in-plane switching (IPS) LCD, the opposition substrate 2220 does not have a transparent conductive layer 2224. In addition, when the color LCD 20 is applied to a multi-domain vertically aligned (MVA) LCD, the transparent conductive layer 2224 has an alignment pattern thereon.

In the present embodiment, the LCD panel 2200 further includes a first polarizer 2240 and a second polarizer 2250. The first polarizer 2240 is disposed between the back light module 2100 and the active device array substrate 2210, and the second polarizer 2250 is disposed on the surface of the opposition substrate 2220 away from the liquid crystal layer 2230. However, in other embodiments, the first polarizer 2240 and the second polarizer 2250 may be respectively replaced by a polarizing layer whose detail will be described in the following.

Because the present embodiment deploys light sources 2120 capable of emitting different color lights to produce the color display effects, both the active device array substrate 2100 and the opposition substrate 2200 do not have a color filter layer. Because the opposition substrate 2200 does not have a color filter layer, there is no need to form a patterned film on the opposition substrate 2200 so that the process for manufacturing the opposition substrate 2200 is simplified.

### Second Embodiment

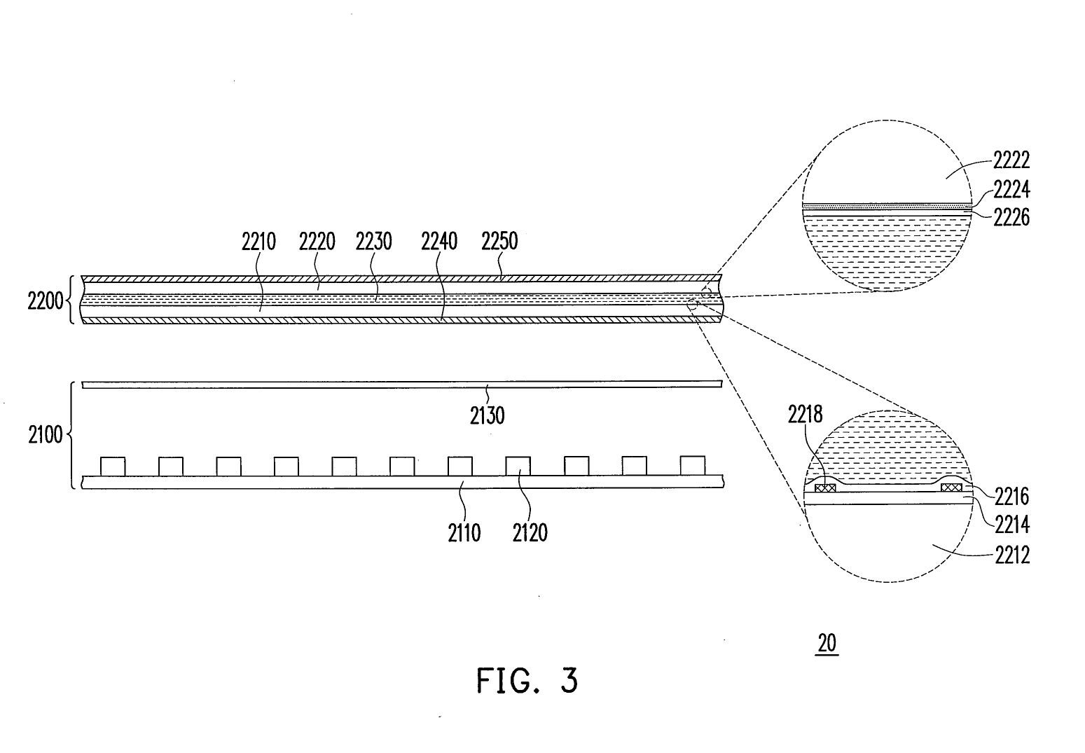

FIG. 3 is a schematic cross-sectional view of a color liquid crystal display according to a second embodiment of the present invention. The present embodiment is similar to the first embodiment. The main difference is that the back light module 2100 in the present embodiment further includes a PS conversion layer 2130 disposed under the LCD panel 2200. More specifically, the P-polarized light (or S-polarized light) from the light sources 2120 originally blocked by the first polarizer 2240 is able to pass through the first polarizer 2240 after the polarizing direction of the passing light beams is changed by the PS conversion layer 2130. Therefore, the light utility of the light sources 2120 is increased. Furthermore, since the light beam from the light sources 2120 is polarized light after passing through the PS conversion layer 2130, the present embodiment does not necessitate the use of the first polarizer 2240. In addition, the present embodiment is not limited to the configuration of the PS conversion layer 2130. For example, the PS converter disclosed in U.S. Pat. No. 5,973,840 or other PS converters can also be applied to the present embodiment. To improve the display quality, the active device array substrate may further include a black matrix layer 2218 disposed between the active device layer 2214 and the first alignment film 2216. The black matrix layer 2218 and the PS conversion layer 2130 may correspond with each other when they are used together in the present embodiment. However, the black matrix layer 2218 and the PS conversion layer 213 can also be used independently.

### Third Embodiment

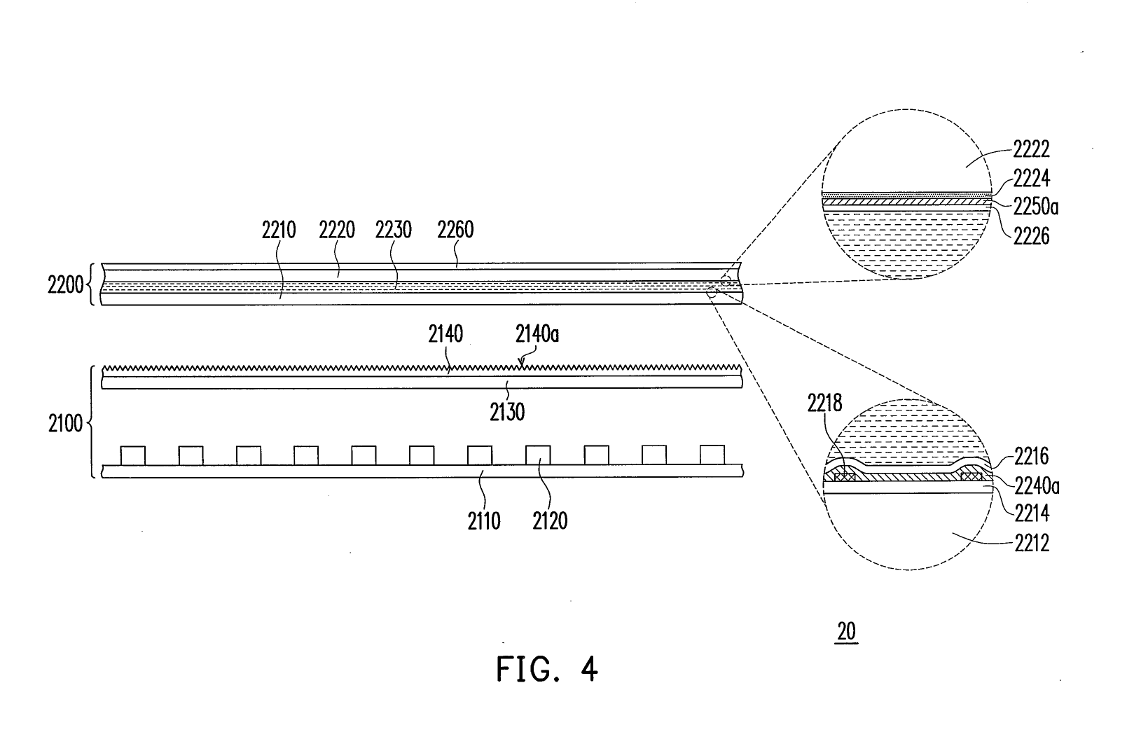

FIG. 4 is a schematic cross-sectional view of a color liquid crystal display according to a third embodiment of the present invention. The present embodiment is similar to the second embodiment. The main difference is that the back light module 2100 in the present embodiment further includes a diffuser disposed between the PS conversion layer 2130 and the active device array substrate 2210. Furthermore, the diffuser 2140 has a brightness enhancement structure 2140a. Therefore, after the light beam emitted from the light sources 2120 has passed through the diffuser 2140, the uniformity and brightness of the light beam is enhanced. In addition, the diffuser 2140 and the brightness enhancement structure 2140a do not have to correspond to each other in the present embodiment, and the diffuser 2140 may be used without the brightness enhancement structure 2140a.

In the present embodiment, the foregoing first polarizer 2240 and a second polarizer 2250 may be separately integrated to the structure of the active device array substrate 2100 and the opposition substrate 2200 respectively. More specifically, the active device array substrate 2100 further includes a first polarizing layer 2240a disposed between the active device layer 2214 and the first alignment film 2216. In addition, the opposition substrate 2200 further includes a second polarizing layer 2250a disposed between the second alignment film 2226 and the second transparent substrate 2222. It should be noted that the first polarizing layer 2240a and the second polarizing layer 2250a do not have to be simultaneously used. For example, in one embodiment, the first polarizer 2240 and the second polarizing layer 2250a may be used together. In another embodiment, the first polarizing layer 2240a and the second polarizer 2250 may be used together.

In addition, the LCD panel 2200 of the present embodiment also includes an optical film 2260 disposed on the surface of the second transparent substrate 2222 away from the second alignment film 2226. For example, the optical film 2260 is a wide-viewing angle film, an anti-glare film or other type of optical films.

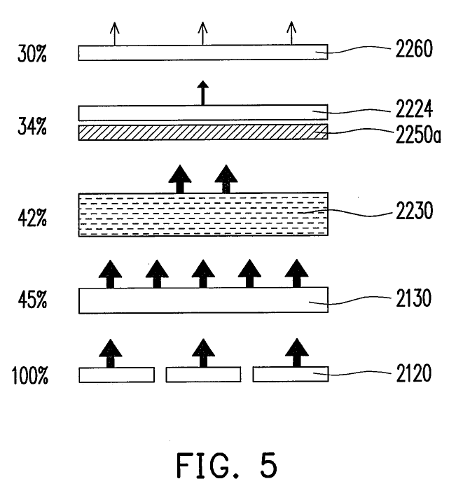

FIG. 5 is a schematic diagram showing the utility of light in the color liquid crystal display according to the third embodiment of the present invention. In the color liquid crystal display as shown in FIG. 5, when the intensity of a light beam emitted from the light source 2120 is 100%, the intensity of the light beam is reduced to 45% after passing through the PS conversion layer 2130. Then, after the light beam from the light source 2120 has passed through the liquid crystal layer 2230, the intensity of the light beam is further reduced to 42%. When the light beam emitted from the light source 2120 passes through the second polarizing layer 2250a and the transparent conductive layer 2224, the intensity of the light beam is further reduced to 34%. Finally, when the light beam emitted from the light source 2120 passes through the uppermost optical film 2260, the intensity of the light beam is further reduced to 30%. Compared with providing just 5% of the light intensity of the light source of the conventional color LCD display, the color LCD display in the present embodiment is able to provide a staggering 30% of the light intensity of the light source. In the following, several driving methods are provided to simplify the driving mechanism. Moreover, these driving methods are not limited to driving the color LCD disclosed in the foregoing embodiments. The driving methods may be applied to other types of color LCD as well.

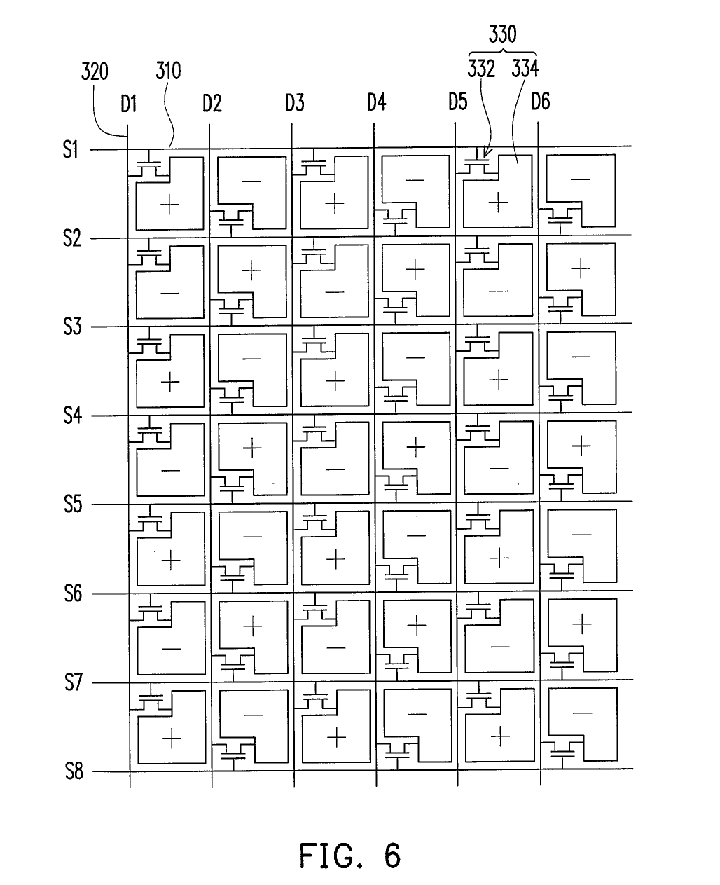

FIG. 6 is a diagram showing a first driving method according to the present invention. As shown in FIG. 6, this driving method is suitable for driving a LCD panel with a plurality of scan lines 310, a plurality of data lines 320 and a plurality of pixel units 330. Each pixel unit 330 includes an active device 332 and a pixel electrode 334 and the active device 332 is electrically connected to pixel electrode 334. In addition, the two neighboring pixel units 330 connected to the same scan line 310 are respectively located on the two sides of the scan line 310. Furthermore, the scan lines 310 are sequentially divided into groups. In the present embodiment, each group of scan lines includes one scan line 310. To simplify the description, only eight groups of scan lines S1 to S8 and eight data lines D1 to D8 are shown in the present embodiment.

With reference to FIG. 6, the driving method includes the following steps. First, the odd-numbered ground of scan lines S1, S3, S5, S7 are sequentially turned on and a signal with first polarity is input to the pixel units 330 controlled by the odd-numbered groups of scan lines S1, S3, S5, S7 through the data lines D1 to D8. Next, the even-numbered ground of scan lines S2, S4, S6, S8 are sequentially turned on and a signal with second polarity is input to the pixel units 330 controlled by the even-numbered groups of scan lines S2, S4, S6, S8 through the data lines D1 to D8. The signal with first polarity and the signal with second polarity have opposite polarities. In the present embodiment, the signal with first polarity is a signal with positive polarity and the signal with second polarity is a signal with negative polarity. More specifically, when the voltage of the signal with first polarity is greater than a common voltage, the signal with first polarity is a signal with positive polarity. In the contrary, when the voltage of the signal with first polarity is smaller than the common voltage, the signal with first polarity is a signal with negative polarity. In addition, the signal with first polarity may be a signal with negative polarity while the signal with second polarity is a signal with positive polarity.

Since the two neighboring pixel units 330 connected to the same scan line 310 are located on two sides of the scan line 310, the pixel units 330 are driven by a frame inversion driving method so as to achieve a dot inversion effect and save electrical power.

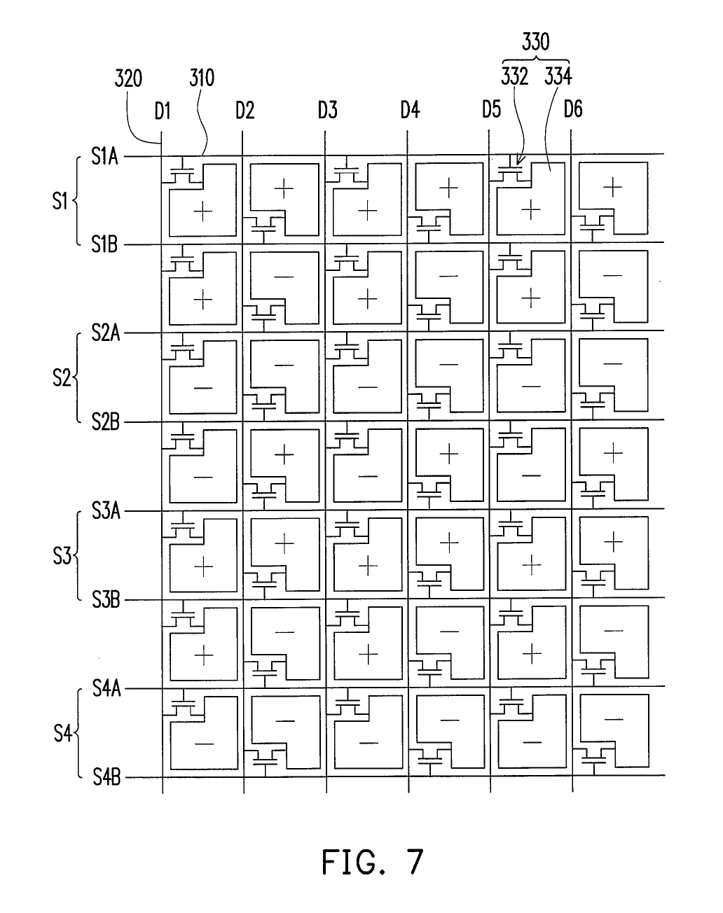

FIG. 7 is a diagram showing a second driving method according to the present invention. FIG. 7 is similar to FIG. 6. The main difference is that each group of scan lines includes two scan lines 310. To simplify the description, only four groups of scan lines S1 to S4 and eight data lines D1 to D8 are shown.

As shown in FIG. 7, the odd-numbered groups of scan lines S1, S3 are sequentially turned on and a signal with first polarity is input to the pixel units 330 controlled by the odd-numbered groups of scan lines S1, S3 through the data lines D1 to D8. More specifically, the odd-numbered groups of scan lines S1, S3 include the scan lines S1A, S1B and the scan lines S3A, S3B respectively. Next, the even-numbered groups of scan lines S2, S4 are sequentially turned on and a signal with second polarity is input to the pixel units 330 controlled by the even-numbered groups of scan lines S2, S4 through the data lines D1 to D8. More specifically, the even-numbered groups of scan lines S2, S4 include the scan lines S2A, S2B and the scan lines S4A, S4B respectively. Furthermore, the signal with first polarity and the signal with second polarity have opposite polarities.

In the present embodiment, the signal with first polarity is a signal with positive polarity and the signal with second polarity is a signal with negative polarity. However, in another embodiment, the signal with first polarity may be a signal with negative polarity while the signal with second polarity is a signal with positive polarity.

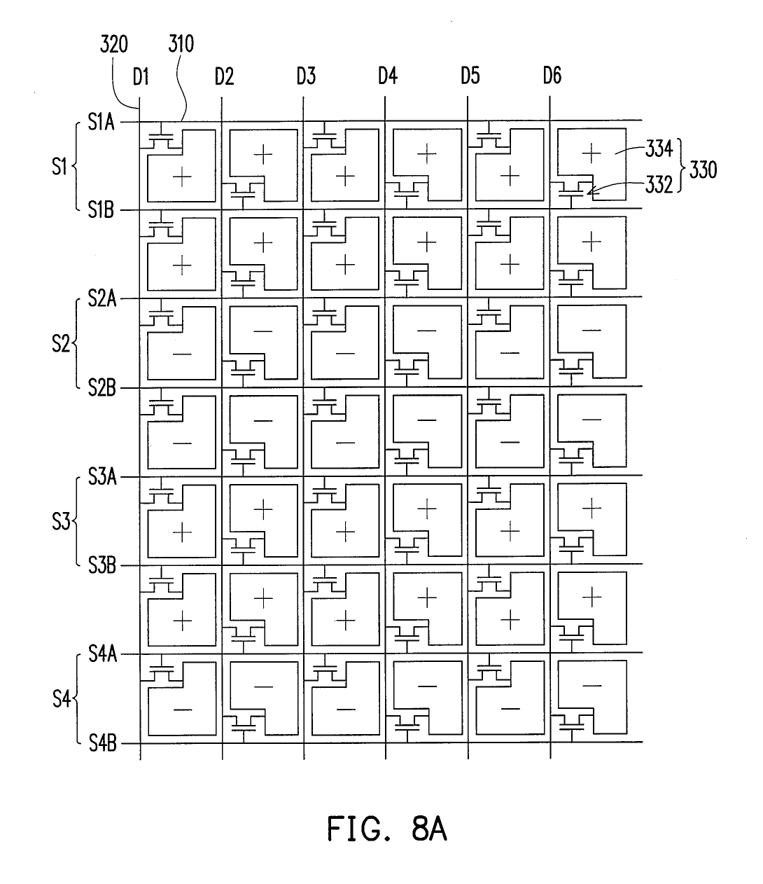

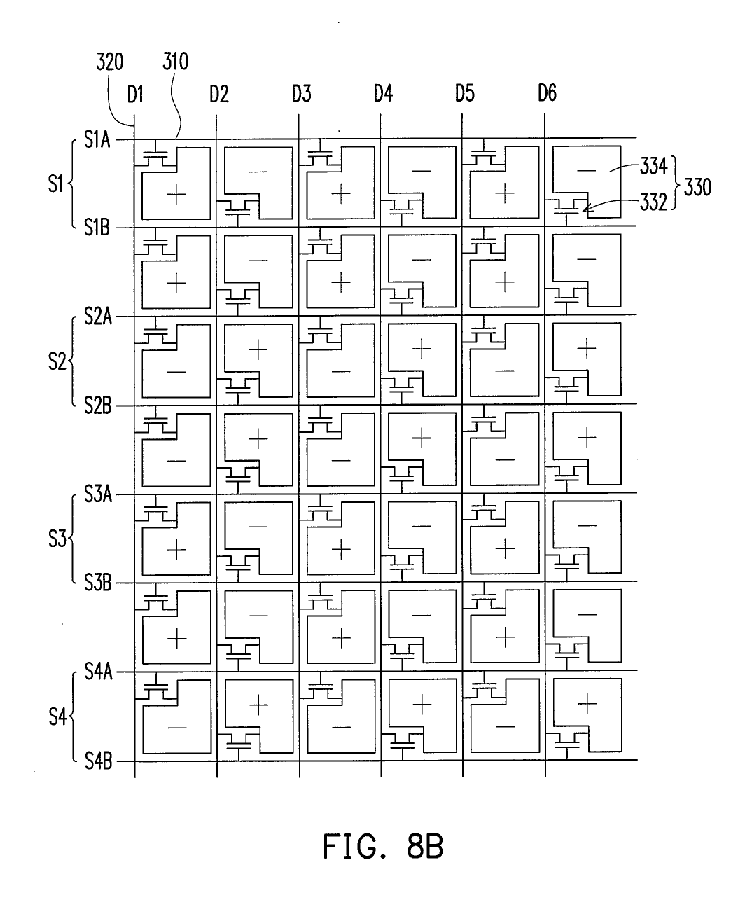

FIGS. 8A and 8B are diagrams showing a third driving method according to the present invention. First, as shown in FIG. 8A, the content shown in FIG. 8 is similar to the content shown in FIG. 7. The only difference is that the data lines 310 are grouped into odd data lines D1, D3, D5 and even data lines D2, D4, D6 in the present embodiment. First, the odd-numbered groups of scan lines S1, S3 are sequentially turned on and a signal with first polarity is input to the pixel units 330 controlled by the odd-numbered scan lines S1, S3 through the odd-numbered data lines D1, D3, D5 and a signal with second polarity and the signal with first polarity are sequentially input to the pixel units 330 controlled by the odd-numbered group of scan lines S1, S3 through the even-numbered data lines D2, D4, D6.

Next, the even-numbered groups of scan lines S2, S4 are sequentially turned on and the signal with second polarity is input to the pixel units 330 controlled by the even-numbered scan lines S2, S4 through the odd-numbered data lines D1, D3, D5 and the signal with first polarity and the signal with second polarity are sequentially input to the pixel units 330 controlled by the even-numbered group of scan lines S2, S4 through the even-numbered data lines D2, D4, D6.

In the present embodiment, the signal with first polarity is a signal with positive polarity and the signal with second polarity is a signal with negative polarity. However, in another embodiment, the signal with first polarity may be a signal with negative polarity while the signal with second polarity is a signal with positive polarity.

As shown in FIG. 8B, the foregoing sequence for inputting the signal with first polarity and the signal with second polarity may be reversed. More specifically, the odd-numbered groups of scan lines S1, S3 are sequentially turned on and the signal with first polarity is input to the pixel units 330 controlled by the odd-numbered groups of scan lines S1, S3 through the odd-numbered data lines D1, D3, D5 and the signal with first polarity and the signal with second polarity are sequentially input to the pixel units 330 controlled by the odd-numbered groups of scan lines S1, S3 through the even-numbered data lines D2, D4, D6. Next, the even-numbered groups of scan lines S2, S4 are sequentially turned on and the signal with second polarity is input to the pixel units 330 controlled by the even-numbered groups of scan lines S2, S4 through the odd-numbered data lines D1, D3, D5 and the signal with second polarity and the signal with first polarity are sequentially input to the pixel units 330 controlled by the even-numbered groups of scan lines S2, S4 through the even-numbered data lines D2, D4, D6.

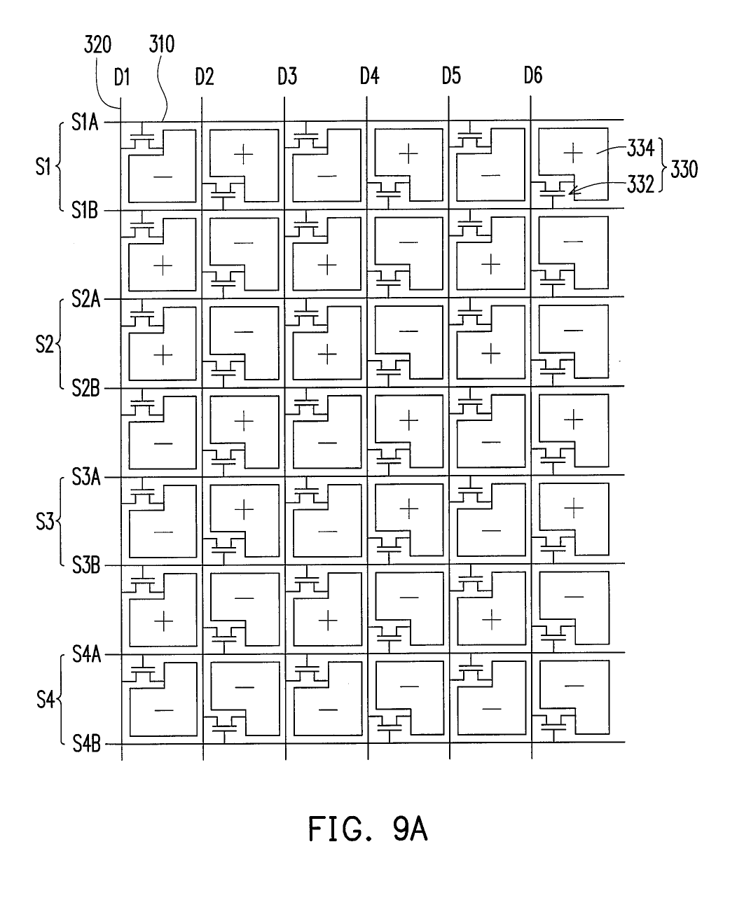

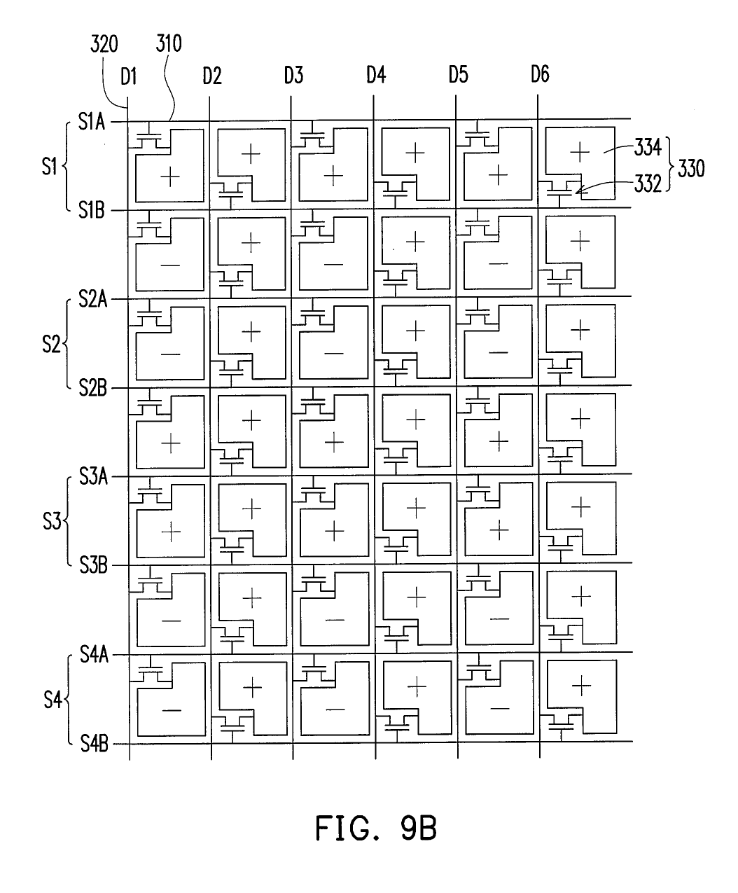

FIGS. 9A and 9B are diagrams showing a fourth driving method according to the present invention. First, as shown in FIG. 9A, the content shown in FIG. 9A is similar to the content shown in FIG. 8A. The only difference is that the signal with second polarity and the signal with first polarity are sequentially input through the odd-numbered data lines D1, D3, D5 in the present embodiment.

In the present embodiment, the signal with first polarity is a signal with positive polarity and the signal with second polarity is a signal with negative polarity. However, in another embodiment, the signal with first polarity may be a signal with negative polarity while the signal with second polarity is a signal with positive polarity.

As shown in FIG. 9B, the content shown in FIG. 9B is similar to the content shown in FIG. 8B. The only difference is that the signal with first polarity and the signal with second polarity are sequentially input through the odd-numbered data lines D1, D3, D5 in the present embodiment.

In the present embodiment, the signal with first polarity is a signal with positive polarity and the signal with second polarity is a signal with negative polarity. However, in another embodiment, the signal with first polarity may be a signal with negative polarity while the signal with second polarity is a signal with positive polarity.

In summary, the color LCD and the driving methods of the present invention has at least the following advantages:

1. Because the light sources inside the back light module can produce different color lights, both the active device substrate array and the opposition substrate do not need a color filter layer. Hence, the processing of the opposition substrate is simplified.

2. Because a PS conversion layer is disposed above the light sources, the utility of light emitted from the light source of the back light module is enhanced.

3. By arranging the pixel units alternately and using frame inversion driving method to produce dot inversion effect, the driving method saves electrical power.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color liquid crystal display, comprising:
a back light module having a plurality of light sources for providing different color lights, wherein the back light module comprises a PS conversion layer disposed under the liquid crystal display panel;
a liquid crystal display panel, comprising:
an active device array substrate;
an opposition substrate, disposed above the active device array substrate, wherein both the active device array substrate and the opposition substrate do not have a color filter layer; and
a liquid crystal layer, disposed between the active device array substrate and the opposition substrate.

2. The color liquid crystal display of claim 1, wherein the light sources comprise a plurality of dot light sources, a plurality of linear light sources or a plurality of plane light sources.

3. The color liquid crystal display of claim 2, wherein the dot light sources comprise red dot light sources, blue dot light sources and green dot light sources, or dot light sources of other colors.

4. The color liquid crystal display of claim 3, wherein the dot light sources comprises light-emitting diodes or organic light-emitting diodes.

5. The color liquid crystal display of claim 1, wherein the back light module further comprises a diffuser disposed between the PS conversion layer and the active device array substrate, and the diffuser has a brightness enhancement structure.

6. The color liquid crystal display of claim 1, wherein the back light module comprises a direct-type back light module or an edge-type back light module.

7. The color liquid crystal display of claim 1, wherein the opposition substrate comprises a second transparent substrate and a second alignment film disposed on the second transparent substrate, and the active device array substrate comprises:
a first transparent substrate;
an active device layer, disposed on the first transparent substrate; and
a first alignment film, disposed on the active device layer.

8. The color liquid crystal display of claim 7, wherein the liquid crystal display panel further comprises a first polarizer disposed between the back light module and the active device array substrate.

9. The color liquid crystal display of claim 8, wherein the liquid crystal display panel further comprises a second polarizer disposed on a surface of the opposition substrate away from the liquid crystal layer.

10. The color liquid crystal display of claim 8, wherein the opposition substrate further comprises a second polarizing layer disposed between the second alignment film and the second transparent substrate.

11. The color liquid crystal display of claim 7, wherein the active device array substrate further comprises a first polarizing layer disposed between the active device layer and the first alignment film.

12. The color liquid crystal display of claim 11, wherein the liquid crystal display panel further comprises a second polarizer disposed on a surface of the opposition substrate away from the liquid crystal layer.

13. The color liquid crystal display of claim 11, wherein the opposition substrate further comprises a second polarizing layer disposed between the second alignment film and the second transparent substrate.

14. The color liquid crystal display of claim 7, wherein the opposition substrate further comprises a transparent conductive layer disposed between the second alignment film and the second transparent substrate.

15. The color liquid crystal display of claim 7, wherein the active device array substrate further comprises a black matrix layer disposed between the active device layer and the first alignment film.

16. The color liquid crystal display of claim 7, wherein the first transparent substrate and the second transparent substrate comprise flexible substrates.

17. The color liquid crystal display of claim 7, wherein the first transparent substrate and the second transparent substrate comprise rigid substrates.

18. The color liquid crystal display of claim 7, wherein the liquid crystal display panel further comprises an optical film disposed on a surface of the second transparent substrate away from the second alignment film.

19. A driving method for driving a liquid crystal display panel having a plurality of scan lines, a plurality of data lines and a plurality of pixel units, wherein two neighboring pixel units are electrically connected to the same scan line are respectively located on two sides of the scan line, and the scan lines are sequentially divided into groups, the driving method comprising:
sequentially turning on odd-numbered groups of scan lines, and inputting a signal with first polarity to the pixel units controlled by the odd-numbered groups of scan lines through the data lines; and
sequentially turning on even-numbered groups of scan lines, and inputting a signal with second polarity to the pixel units controlled by the even-numbered groups of scan lines through the data lines, wherein the signal with first polarity and the signal with second polarity have opposite polarities.

20. The driving method of claim 19, wherein each group of scan lines comprises one scan line.

21. The driving method of claim 19, wherein each group of scan lines comprises two scan lines.

22. A driving method for driving a liquid crystal display panel having a plurality of scan lines, a plurality of data lines and a plurality of pixel units, wherein two neighboring pixel units are electrically connected to the same scan line are respectively located on two sides of the scan line, and the scan lines are sequentially divided into groups with each group of scan lines including two scan lines, the driving method comprising:
sequentially turning on odd-numbered groups of scan lines, and inputting a signal with first polarity to the pixel units controlled by the odd-numbered groups of scan lines through odd-numbered data lines and inputting a signal with second polarity and the signal with first polarity to the pixel units controlled by the odd-numbered groups of scan line through even-numbered data lines; and
sequentially turning on even-numbered groups of scan lines, and inputting the signal with second polarity to the pixel units controlled by the even-numbered groups of scan lines through the odd-numbered data lines and inputting the signal with first polarity and the signal with second polarity to the pixel units controlled by the even-numbered groups of scan lines through the even-numbered data lines.

23. The driving method of claim 22, wherein the step of turning on the odd-numbered groups of scan lines comprises sequentially inputting the signal with second polarity and the signal with first polarity through the even-numbered data lines, and the step of turning on the even-numbered groups of scan lines comprises sequentially inputting the signal with first polarity and the signal with second polarity through the even-numbered data lines.

24. The driving method of claim 22, wherein the step of turning on the odd-numbered groups of scan lines comprises sequentially inputting the signal with first polarity and the signal with second polarity through the even-numbered data lines, and the step of turning on the even-numbered groups of scan lines comprises sequentially inputting the signal with second polarity and the signal with first polarity through the even-numbered data lines.

25. The driving method of claim 22, wherein the signal with first polarity is a signal with positive polarity and the signal with second polarity is a signal with negative polarity.

26. The driving method of claim 22, wherein the signal with first polarity is a signal with negative polarity and the signal with second polarity is a signal with positive polarity.

27. A driving method for driving a liquid crystal display panel having a plurality of scan lines, a plurality of data lines and a plurality of pixel units, wherein two neighboring pixel units are electrically connected to the same scan line are respectively located on two sides of the scan line, and the scan lines are sequentially divided into groups with each group of scan lines including two scan lines, the driving method comprising:
sequentially turning on odd-numbered groups of scan lines, and inputting a signal with second polarity and a signal with first polarity to the pixel units controlled by the odd-numbered groups of scan lines through odd-numbered data lines and inputting the signal with first polarity to the pixel units controlled by the odd-numbered groups of scan line through even-numbered data lines; and
sequentially turning on even-numbered groups of scan lines, and inputting the signal with first polarity and the signal with second polarity to the pixel units controlled by the even-numbered groups of scan lines through the odd-numbered data lines and inputting the signal with second polarity to the pixel units controlled by the even-numbered groups of scan lines through the even-numbered data lines.

28. The driving method of claim 27, wherein the step of turning on the odd-numbered groups of scan lines comprises sequentially inputting the signal with second polarity and the signal with first polarity through the odd-numbered data lines, and the step of turning on the even-numbered groups of scan lines comprises sequentially inputting the signal with first polarity and the signal with second polarity through the odd-numbered data lines.

29. The driving method of claim 27, wherein the step of turning on the odd-numbered groups of scan lines comprises sequentially inputting the signal with first polarity and the signal with second polarity through the odd-numbered data lines, and the step of turning on the even-numbered groups of scan lines comprises sequentially inputting the signal with second polarity and the signal with first polarity through the odd-numbered data lines.

30. The driving method of claim 27, wherein the signal with first polarity is a signal with positive polarity and the signal with second polarity is a signal with negative polarity.

31. The driving method of claim 27, wherein the signal with first polarity is a signal with negative polarity and the signal with second polarity is a signal with positive polarity.
